(19) United States
(12) Patent Application Publication
(10) Pub. No.: US 2019/0292022 A1
(43) Pub. Date: Sep. 26, 2019

(54) REINFORCED DYNAMIC LIFTING ANCHOR FOR LIFTING, TURNING OVER A BUILDING ELEMENT

(71) Applicants: Marcel ARTEON, Bayonne (FR); Patrick LAPOULE, Bayonne (FR)

(72) Inventors: Marcel ARTEON, Bayonne (FR); Patrick LAPOULE, Bayonne (FR)

(21) Appl. No.: 16/329,398

(22) PCT Filed: Sep. 2, 2016
(86) PCT No.: PCT/FR2016/052179

§ 371 Date: May 16, 2019

(51) Int. Cl. B66C 1/66; E04G 21/14

(52) U.S. Cl. CPC B66C 1/66; E04G 21/142

(57) ABSTRACT

The disclosure relates to a lifting anchor for lifting a building element, such as a concrete panel, including a head part that can be attached to a lifting ring, a foot and a body interposed between the head and the foot. The body and the foot are intended to be immersed in the material of which the building element is made. The anchor extends in a main plane along a longitudinal axis. The anchor also includes at least two sub-parts, each one defining various successive portions respectively forming the head, the body and the foot of the anchor. The anchor includes at least one reinforcing piece interposed between the two flats or flat parts, extending from the head of the anchor over at least part of the foot.

### CROSS-REFERENCE TO RELATED APPLICATIONS

[000.1] This application is a National Phase Entry of International Patent Application No. PCT/FR2016/052179, filed on Sep. 2, 2016, which is incorporated by reference herein.

### BACKGROUND AND SUMMARY

The invention relates to a dynamic anchor for lifting a structural member, such as a horizontally cast concrete panel, in particular, which makes it possible to lift said panel without any mechanical means nor additional framing.

Such anchor knowingly comprises a head part able to be coupled with a gripping ring, a foot and a body interposed between the head and the foot, with the head and the foot being intended to be embedded in the material which the structural member is made of, with the anchor being obtained by folding at least one flat defining different successive portions that form the head, the body and the foot of the anchor, respectively. An anchor comprising a stiffening frame, formed at the anchor foot by two opposite diverging flat branches and two converging lower branches, has the advantage of maintaining the angle of the diverging branches and thus the amplitude of the compression cone generated upon lifting a structural member. Such type of anchor is however not specifically adapted to the lifting of particularly heavy structural members, and the field of application thereof is thus restricted.

The invention aims remedying these disadvantages. For this purpose, the invention relates to an anchor for lifting a building element, such as a concrete panel, comprising a head part capable of being attached to a gripping ring, a foot and a body interposed between the head and the foot, the body and the foot being intended to be immersed in the material constituting the building element, the anchor extending along a main plane along a longitudinal axis and comprising at least two sub-parts, each defining different successive portions forming respectively the head, body and foot of the anchor. According to the invention, the anchor comprises a reinforcing piece interposed between the two flats or sub-parts extending from the head of the anchor along at least a part of the body.

The invention may also provide for one and/or the other of the following aspects:
the anchor is obtained by folding a single flat comprising at least two continuously connected sub-parts of the anchor;
the anchor is composed of at least two separate sub-parts, each one being obtained by folding at least one flat;
the reinforcing piece is an independent part inserted on the anchor;
the reinforcing piece is a part continuously connected with the anchor, obtained by folding a flat containing at least a sub-part of the anchor;
the constituent portions of the foot of the anchor comprising two lower branches diverging on either side of the anchor body, and two branches converging towards each other and extending from the diverging branches;
the anchor comprises means for locking 21, 22, 26 the converging branches against one another;
the means for locking one converging branch to the other comprise at least one protrusion formed on the lower free edge of the converging branch, and a recess for accommodating such protrusion, provided in the thickness of the opposite diverging branch from the lower free edge thereof, with the protrusion being engaged into the recess when the portions of the flat heads of the anchor and the reinforcing part interposed between same, are pressed against each other;
the locking means comprise a single protrusion transversally offset relative to the center of the free edge of the diverging branch, and a cut forming the accommodating recess, with the two lower free edges of the two converging branches each comprising a single protrusion and one cut;
the locking means comprise several protrusions and several cuts, with the protrusions and the cuts alternating along the lower free edge of the converging branch, with the two lower free edges of the two converging branches each having several protrusions and several cuts forming notches;
the reinforcement comprises an aperture for the passage of the locking means provided in the thickness of same;
the anchor comprises at least one outer tilt-up rib on each of the external faces of the two paired sub-parts;
the outer rib extends along a longitudinal axis of the anchor or along an inclined direction relative to such axis;
the two paired sub-parts, and/or at least one of the sub-parts and the central reinforcement are secured together by means of a material bridge formed by a flat part folded along a folding line;
the folding line extends along a side edge of the anchor head, or an upper edge of the anchor head or a lower edge of the anchor foot;
the anchor includes at least one lateral return 16a, 16b along the body, extending in a plane outside the main plane of the body; and
the lateral return is with a delta shape from the head.

### BRIEF DESCRIPTION OF THE DRAWINGS

The invention will now be described while referring to the appended figures which schematically show the various embodiments of the invention, among which:

FIGS. 1 and 2 show perspective views of an anchor according to a first embodiment of the invention, not assembled (FIG. 1) and assembled (FIG. 2);

FIGS. 3 and 4 show perspective views of an anchor according to a second embodiment of the invention, not assembled (FIG. 3) and assembled (FIG. 4);

FIGS. 5 and 6 show perspective views of an anchor according to a third embodiment of the invention, not assembled (FIG. 5) and assembled (FIG. 6);

FIGS. 7A and 7B show an alternative embodiment of a lifting and tilt-up anchor advantageously provided with two longitudinal ribs that protrude outwards from the side faces of the two flats, and respectively in a front view 7A and a perspective view 7B, with FIG. 7A further illustrating, in dotted lines, the possibility of interposing a central reinforcement between the two flats provided with the external longitudinal ribs;

FIGS. 8 to 11 show perspective views of an alternative embodiment of the assembly of two flats constituting a not reinforced anchor (FIGS. 8 to 10), and a reinforced anchor (FIG. 11) enabling a relatively stationary holding of the various flats constituting the anchor;

FIG. 12 schematically shows a flat view of the various flats constituting the anchor of FIG. 11 and the junctions thereof in pairs;

FIGS. 13A and 13A′ respectively represent a flat and an anchor with an inserted reinforcement made by a lateral folding from this flat;

FIGS. 13B and 13B′ respectively represent a flat and an anchor with an inserted reinforcement made by a lateral folding from this flat;

FIG. 13C schematically shows a flat view of a flat intended to make an anchor that can be used as a reinforcement;

FIGS. 13C′ and 13D represent two alternative embodiments of an anchor that can be used as a reinforcement with a different foot length;

FIGS. 14A, 14B, 14C, 14′ and 14″ represent in perspective views the alternative embodiments of an anchor by means of a longitudinal folding;

FIGS. 15A, 15A′, 15A′, 15A′, 15B and 15C represent in perspective views the alternative embodiments of an anchor by means of a series of lateral and longitudinal fold ings;

FIGS. 16, 16A and 16B show perspective views of the alternative embodiments of the anchor body; and

FIGS. 17, 17A-C and 18, 18A-C show the alternative anchor assemblies with a reinforcement and a plate in perspective views.

### DETAILED DESCRIPTION

According to the appended figures, the anchor according to the invention comprises a head part 1, a part 2 forming the body of the anchor and a part 3 forming the foot. Except for the head 1 which remains outside the material of the building element and which is adapted to be hooked to a handling device, the anchor is intended to be embedded in the material which the building element is made of, the anchor of which aims at facilitating the handling. Generally speaking, such structural member may be a concrete slab or panel, and the head 1 of the anchor is accessible from a free section of the panel within which a recess or “reservation” has been provided for, which lets the anchor head 1 out, whereas the anchor body 2 and foot 3 are embedded in concrete.

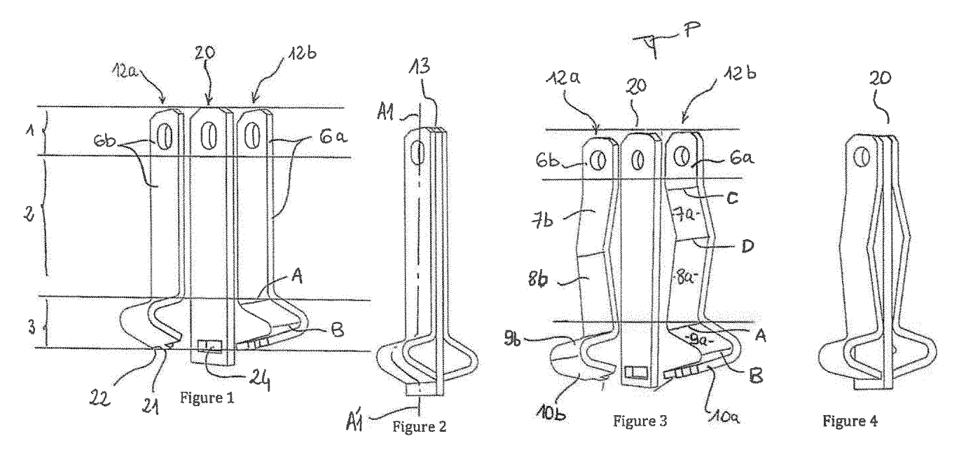

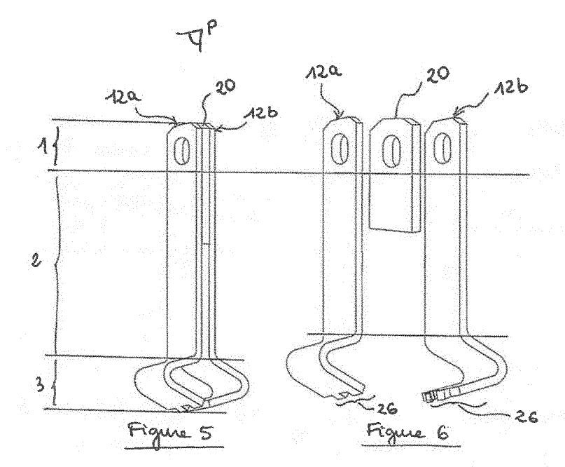

According to FIG. 3, the anchor is made from two identical flats 12a, 12b, i.e. two rigid strips, for instance made of metal, the thickness of which is low relative to the width thereof, which are each folded along four folding lines C, D, A, B so as to successively define, for the considered flat, and according to FIG. 1 (with the references associated with letter “a” relating to flat 12a, with the references associated with “b” relating to flat 12b):
a vertical head part 6a pressed against the head part 6b of the other flat, extending in a plane P;
a branch 7a, 7b which extends under the head part 6a and diverges above the plane formed by such head part, along a low angle of approximately 15° for example, with the two branches of the two flats diverging from each other in the direction of the anchor foot;
a converging branch 8a, 8b which extends under the branch 7a on a more or less significant length, for example of approximately 8 to 13 cm, which makes it possible to hold the anchor foot deep inside the structural member;
a lower diverging branch 9a inclined above the main plane of the flat P defined by the head 6a, 6b of the anchor, at an angle of about 70°;
a converging branch 10a which extends under the diverging branch to join the plane P and to have the lower end resting against that of the converging branch 10b of the other flat.

Such flats are generally less than 15 mm thick, in order to enable the folding thereof along the folding lines A-D. Such anchor, having two paired flats is so positioned in the panel that the plane wherein the width of the flats is inscribed is the same as the tilt-up plane.

The lower diverging branches 9a, 9b define active faces which, when combined with the developed surface of the flat, make it possible to stress both the adherence and shearing of concrete at right angles with the anchorages generated by the surfaces. Because they are inclined relative to the main plane P, such branches 9a, 9b define, upon lifting, a compression area centered on the main plane of the anchor, the apex of which is located towards the anchor foot and the base of which extends about the anchor head. The amplitude of the base of the compression area is greater when a branch 9a, 9b is inclined by almost 45°, and smaller when such inclination is close to a horizontal plane. The converging branches 10a, 10b which, according to such embodiment, are in mutual contact by their lower end edges, make it possible to keep the inclination of the diverging branches constant relative to the longitudinal plane P of the flat when lifting the panel.

The anchor may also comprise a reinforcing part interposed between the two flats to increase the strength of the anchor and thus enable the lifting of particularly heavy structural members. According to a special embodiment, the reinforcing part consists of a plate 13, preferably having a length and a width substantially similar to those of a protrusion of the flats 12a, 12b between which it is positioned in the plane P. The plate, positioned in the plane P, thus has an upper end portion engaged between the end parts of the two flats defining the head of the anchor, with the lower end being held between the lower edges of the lower converging branches 10a, 10b.

In order to make it possible to lock the two converging branches 10a, 10b relative to the reinforcing plate, such two branches 10a, 10b and the portion opposite the plate, comprise mutual locking means. In the example shown in FIG. 1, such additional means comprise two flat 21 protrusions which respectively extend the two converging branches 10b beyond the two lower transversal edges 22 thereof, and an opening 24 is provided in the thickness of the reinforcing plate 20 so as to accommodate the two protrusions 21 of the two converging branches 10a, 10b. Such opening will be so formed as to accommodate the two protrusions, i.e. it will have a width slightly greater than the added width of the two protrusions, and a height which will take account of the inclination of such protrusions (which is that of the converging branches) so as to make it possible to insert same into the opening when simply moving both flats 12a, 12b towards the plate 20.

In the examples of FIGS. 1 to 4, the protrusions of the two converging branches are mutually offset relative to the longitudinal axis AI-AI′ of each flat so as to enable the simultaneous insertion thereof into the aperture. As a matter of fact, the protrusions of the two flats are shifted relative to the axis AI-AI′ by the same distance, so that both flats are identical and can be positioned on either side of the plane P. In fact, the protrusions are each so positioned as to be able to be adjacent upon assembling the flats around the plate 20, i.e. with a side edge coinciding with the axis AI-AI′.

The anchor according to the FIGS. 1 and 2 also comprises two flats 12a, 12b assembled on either side of a reinforcing plate 20, the converging branches 10a, 10b of which are provided with protrusions 21 which engage into a matching opening 24 of the plate 20, and the protrusions and the opening comply with the description above, which refers to the FIGS. 3 and 4, but the bodies 2 of the two flats have no diverging and converging intermediate faces, so that the body 2 of each flat simply extends from the head 6a, 6b in the plane P. In the example shown in FIGS. 5 and 6, the reinforcing plate 20 interposed between the two flats 12a, 12b does not extend on the length of the protrusion in the plane P of the two flats, but substantially half-way of the flat body. Therefore, it does not need being provided with an aperture for the passage of the protrusions of the converging branches since it remains inserted between the head portions and the upper part of the anchor body.

The converging branches are provided with means for directly locking same together, which are matching notches 26 provided on the lower transversal edges of the branches. Most preferably, the two facing flats provided with notches are identical. The recessed parts of the notches of a converging branch enable the protrusions of the notches of the other converging branch to engage.

In both discussed embodiments, the reinforcement can be attached to the two flats, by means of rivets, at the anchor head and/or the anchor body. The central reinforcement can be provided between two ribbed flats constituting the anchor.

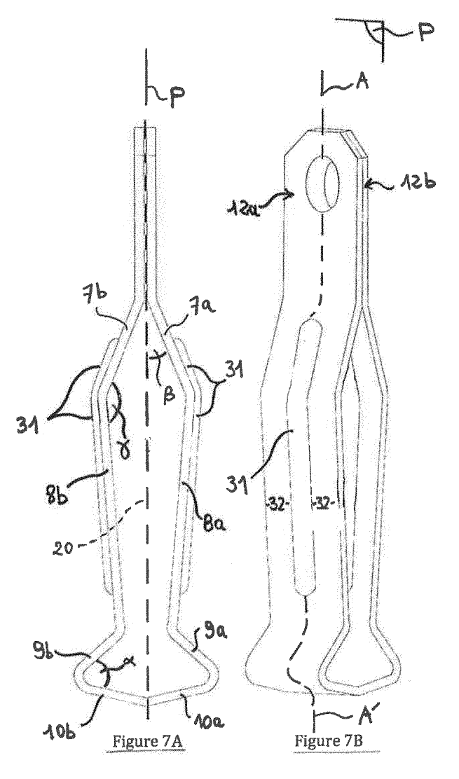

More precisely, and according to the alternative embodiment illustrated in FIGS. 7A and 7B, the anchor may comprise two longitudinal ribs 31 which protrude outwards the outer side faces 32 of the two flats. Such longitudinal ribs make it possible to obtain an efficient lifting and tilting anchor since the flat mass of concrete is trapped above the upper surface of the ribs when the panel is tilted up from a horizontal position to a vertical position. Such outer ribs can be formed by recessing the flats of one anchor using a punch with a shape adapted to the desired rib shape. According to such shape, the optimum tilting-up stress profile can be obtained. The shape of each rib can thus be optimized to reach this objective.

In the illustrated example, the anchor consists of two paired flats which form together a foot with diverging branches 9a, 9b specifically at 45° and underlying converging branches 10a, 10b forming an angle of approximately 60°-70° with the converging branches, intermediate adherence faces 7a, 7b, 8a, 8b the upper faces 7a, 7b of which form an angle (3 of approximately 15°) with the plane P, and the lower faces 8a, 8b form an angle y of approximately 160° with the matching upper face. In this example, the outer rib 31 extends along a lower portion of the upper face 7a, 7b, extends on the lower face 8a, 8b up to the vicinity of the foot (difference of approximately 1/10 of the total length of the anchor). It has a width equivalent to approximately one fourth of the width of the flat, and the height of the outer bump it forms is equivalent to the thickness of the flat.

In the illustrated example, the rib has a generally oblong shape. It may advantageously have a substantially triangular shape. Of course other rib profiles can be considered, as well as other implantations on the flat. Several external ribs can specifically be provided on the outer faces of the flats, may extend on a more or less significant length, be more or less inclined relative to the mid line of the anchor, not straight, broken, interrupted . . . . An anchor with paired flats may also include flats provided with external ribs and may not necessarily be provided with a central flat.

Besides, as shown in FIGS. 11 and 12, the central reinforcement 20 can be secured to one of the two flats 12a using a folding line of the flat 33 interposed as shown in FIG. 2, between two of flat parts in an end-to-end engagement in the “flat” or “not shaped yet” configuration of the anchor and forming, when the anchor is shaped, the central reinforcement 20 and one of the two flats 12a. According to FIG. 11, such folding line 33 coincides with the lower end of the anchor foot when shaped. Besides, the reinforcement 20 can be secured to the other flat 12b using a second folding line 36 interposed as shown in FIG. 12, between two flat parts side by side in the “flat” configuration of the anchor, and forming the central reinforcement 20 and the other flat 12b when the anchor is shaped. The second folding line 36 coincides with an upper side portion of the anchor.

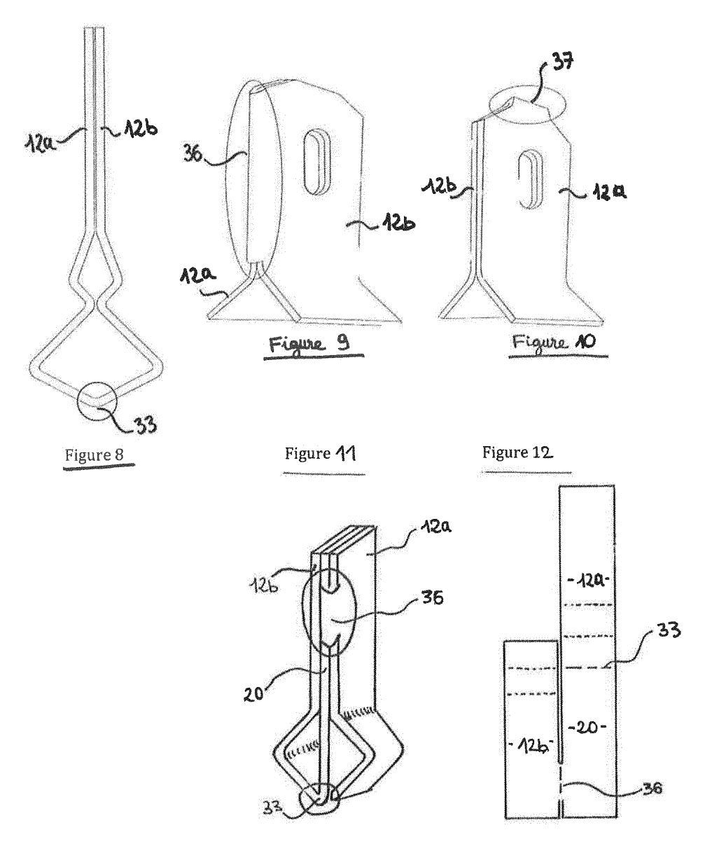

As shown in FIGS. 8 to 9, when the anchor has no central reinforcement, assembling two flats together by folding or flat fold integral with two flats and forming a junction between same, can be achieved at the lower end of the anchor, between the two converging branches of two flats constituting the anchor (FIG. 8) thanks to the folding line 33, on a side portion of the anchor head (FIG. 9) between the two side edges of the two head portions of two flats paired by the folding line 36, or at the upper end of the anchor, between the two upper edges of the two head portions of the two paired flats (FIG. 10) by the folding line 37. The “pattern” from which such three anchors are formed comprises:

FIG. 8: two flat portions in end-to-end alignment, the length of which coincides with the deployed length of each shaped flat, with these two flat portions being separated by a line, half-way, which is liable to be the folding line 33. The flat will comprise additional folding lines so as to define two slightly diverging upper branches (for example at 15° relative to the plane P), two upper converging branches joining the plane P, and one stiffening frame with 45° diverging branches and converging branches at an angle of approximately 80°. The total length of the anchor can ideally range from 100 to 400 mm, the width of the flat can be 20, 25, 30, 40, 60 or 80 mm, the thickness of the flat can range from 3 to 8 mm.

FIG. 9: two flat parts positioned side by side and joined by a flat bridge, the width of which is almost equal to two flat thicknesses, with the mid line of such material bridge being liable to be the folding line 36.

FIG. 10: two flat parts in end-to-end alignment, having a length which coincides with the deployed length of each shaped flat, with these two flat parts being separated by a line, half-way, which is liable to be the folding line 37, and positioned at a shrunk part intended to form the upper edge of the anchor with a smaller width than the rest of the anchor head and body.

As it appears from the description above and the figures, the anchor according to the invention has major advantages relative to the anchors of the state of the art. An anchor of this type is produced using a simple and inexpensive manufacturing method based on the folding of a single or of two flat(s) which makes it possible to lift relatively heavy building elements, thanks to the reinforcement. Of course, the special features of the embodiments, such as the square-, triangle- or diamond-sectioned shape of the box, the 10, 20, . . . 45 degree inclination of the lower diverging branches, the presence or the absence of upper diverging branches within the anchor body, the number thereof, may be combined together in order to define an optimum anchoring according to the building element to be lifted. One or more reinforcement(s) may also be provided between the flats of the anchor, with such reinforcements further possibly having various shapes, in addition to flats.

Anchors Manufactured by Folding

In one embodiment, the anchors are manufacturing by folding. This technique makes it possible to simplify manufacturing and, above all, to eliminate assembly problems. Anchors with an independent flat require assembly by welding, riveting and gluing, which leads to problems of alignment of offset holes and problems of non-jointed anchors. This new anchoring concept, by successive folding of smaller steel thicknesses, makes it possible to economically obtain anchors with higher strength.

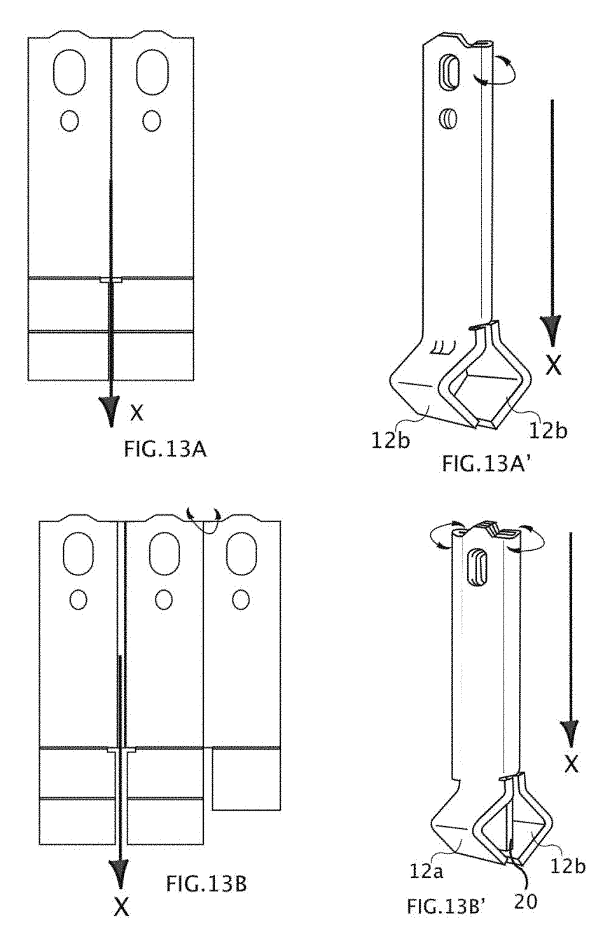

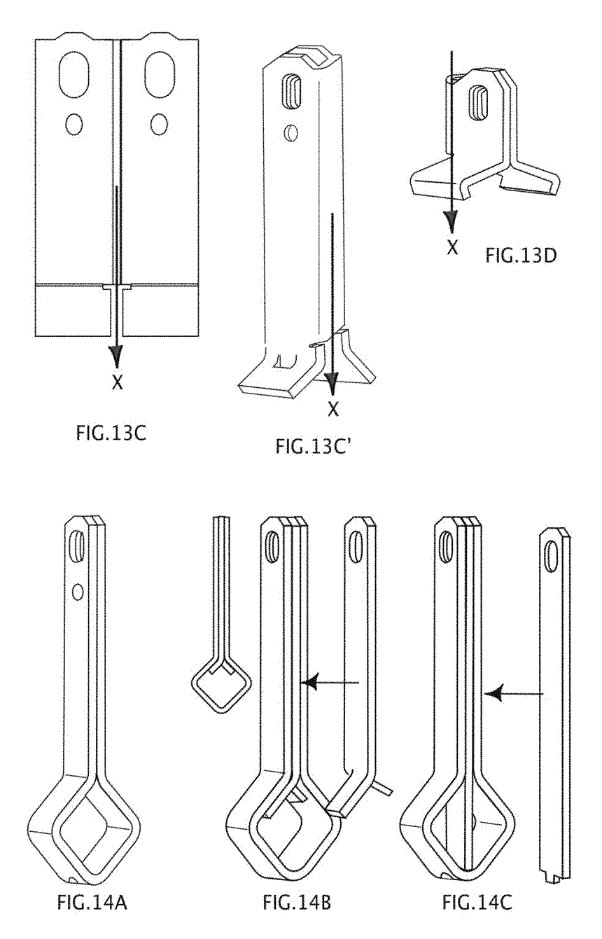

The anchor extends along a main plane along a longitudinal axis X (as shown in the FIGS. 13 to 18), i. e. the portions forming the head, the body and the foot extending along the longitudinal axis X are successively positioned. Nevertheless, the various embodiments of each portion may have branches deviating from the longitudinal axis X. For example, the foot portion may consist of the two diverging and converging branches forming a diamond and deviating from the main plane of the longitudinal axis X. It is also possible to have the foot portion consisting of only two diverging branches.

In a first category, the anchor is made by a lateral folding of a single piece of a flat. FIG. 13A illustrates a flat plate, on which are formed two sub-parts of the anchor, each with the portion of the head, the body and the foot. Between the two sub-parts of the anchor, a lateral fold is provided along the longitudinal axis X. When applying a lateral folding process, both sub-parts are laterally pressed against each other so that they overlap as indicated by the double semi-circular arrows in FIG. 13A′. In FIG. 13A of the flat, two foot folds are also provided to form the two diverging and converging branches of the foot portion. FIG. 13A′ illustrates an anchor thus formed with a thickness layer. In addition to this embodiment with only two sub-parts of the anchor, it is possible to produce an anchor with multiple sub-parts ((3, 4, 5 . . . ) on a single flat. After implementing a method consisting of several successive lateral foldings, an anchor with several thickness layers is obtained.

FIG. 13B shows a flat, on which two sub-parts of the anchor and a reinforcing piece are formed. The two sub-parts of the anchor are the same as those shown in FIGS. 13A and 13A′. The reinforcing piece mainly has the head and the body, optionally the foot. Between one of the anchor sub-parts and the reinforcing piece, a lateral fold is provided along the longitudinal axis X. The lateral folding method is applicable in two ways to obtain the reinforcement installed either inside or outside the anchor. In the first way, the reinforcement is pressed laterally towards the next sub-part as indicated by the double semi-circle arrows in FIG. 13B. Then, the other sub-part is laterally pressed to superimpose this sub-part above the reinforcement to make an anchor with a reinforcement interposed between the two sub-parts as shown in FIG. 13B′. The foot of the reinforcement can extend straight or inclined according to the angle of one of the diverging branches. In the second way, the two sub-parts are first laterally pressed to form an anchor. Then, the reinforcement to be superimposed on top of a sub-part is laterally pressed against it. The foot of the reinforcement is superimposed on one of the diverging branches. It is possible to provide several reinforcements on a flat to increase rigidity. It is also possible to provide a plurality of reinforcements and a plurality of sub-parts of the anchor on a single flat. By a series of lateral folding processes, a reinforced anchor with several reinforcements and a plurality of sub-parts is produced.

FIGS. 13C and 13D are alternative embodiments of the anchor to those presented in FIGS. 13 A and B. A double lateral fold is provided which can define a varied distance between the two sub-parts of the anchor. After the lateral folding process, the anchor can also be used as a reinforcement superimposed over another anchor as shown in FIG. 13C′. Depending on the length of the foot, the anchor can have two diverging lower branches as in FIG. 13C or also two converging branches extending from the diverging branches as in FIG. 13D.

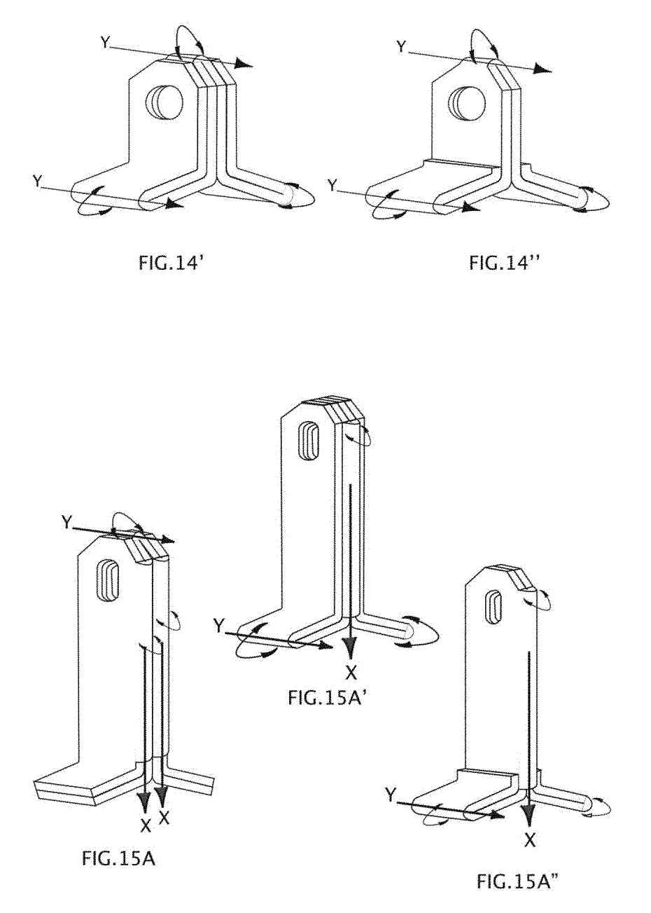

In a second embodiment, the anchor is achieved by a longitudinal folding of a single flat. When a longitudinal folding process is applied, both sub-parts are pressed longitudinally. FIG. 14A shows an anchor formed by a longitudinal folding of the two sub-parts along a fold along the lateral axis Y laterally to the foot position. It is also possible to produce an anchor formed by a folding longitudinally to the head position. Apart from this embodiment with only two sub-parts of the anchor, one anchor can be produced with multiple sub-parts (3, 4, 5 . . . ) on a flat. After the implementation of a method consisting of several successive longitudinal foldings, an anchor with several thickness layers is obtained. FIG. 14A′ shows an anchor formed by a folding longitudinally to the head position and two longitudinal folds at the ends of the diverging branches of the foot portion.

It is also possible to form an anchor with one or more reinforcements through a series of longitudinal foldings from a single flat. FIG. 14A″ shows an anchor formed by a folding longitudinally to the head position, with two reinforcements—each superimposed on the outside of a divergent branch of the foot portion by a longitudinal fold.

In addition, from the anchor shown in FIG. 14A, there are several possibilities to integrate an independent reinforcement. As shown in FIG. 14B, an inverted independent Y-shaped reinforcement is inserted between the two anchor sub-parts. As shown in FIG. 14C, a perfectly straight independent reinforcement is inserted between the two anchor sub-parts. It is also possible to superimpose a reinforcement as shown in FIG. 13C′ above the anchor as shown in FIG. 14A.

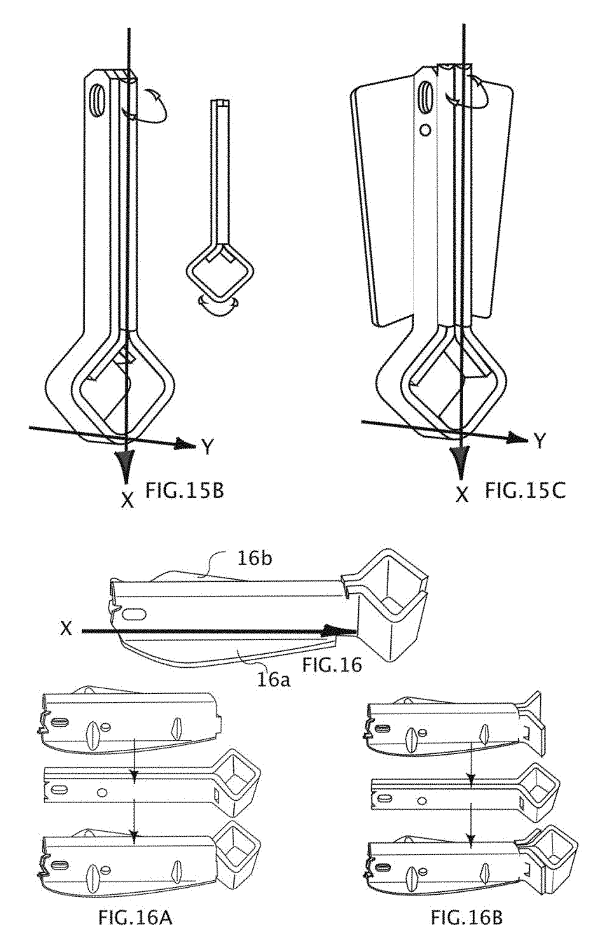

In a third embodiment, the anchor is made by means of a series of lateral and longitudinal foldings of a single flat. FIG. 15A shows a method for producing an anchor with four sub-parts formed by one longitudinal folding and two lateral folding. The two lateral foldings give two lateral folds in the X direction, each of the two folds connecting two sub-parts of the anchor. While the longitudinal folding gives a fold at the head in the Y direction, which connects the four sub-parts of the anchor.

FIG. 15A′ shows another way of producing an anchor with four sub-parts formed by one lateral folding and two longitudinal folding. The two longitudinal foldings give two folds at the ends of the branches diverging from the foot portion in the Y direction, each of the two folds connecting two sub-parts of the anchor. While the lateral folding gives a lateral fold in the X direction, which connects the four sub-parts of the anchor.

Through a series of lateral and longitudinal foldings of a single flat, it is also possible to form an anchor with a reinforcement. An example is shown in FIG. 15A″, in which the anchor is formed through a lateral folding in the X direction. The two reinforcements are on the outside of the two diverging branches of the foot portion, formed by two longitudinal foldings.

FIG. 15B shows a reinforced anchor formed by a first lateral folding along a fold I-I along the longitudinal axis X and a second longitudinal folding along another fold II-II along the lateral axis Y. Because of the first lateral folding, an inverted Y-shaped reinforcement is placed side by side with a sub-part of the anchor, while, because of the second longitudinal folding, the other sub-part of the anchor is interposed on the other side of the reinforcement.

FIG. 15C shows a reinforced anchor formed through two lateral foldings along the longitudinal axis X and one longitudinal folding along the lateral axis Y. Because of the two lateral folds, each reinforcement is placed next to a sub-part of the anchor, while because of the longitudinal folding, the two anchor sub-parts block the two reinforcements in the middle.

FIG. 16 shows a variation in the shape of the anchor body, which includes two lateral returns 16a, 16b along the body. Using a lateral folding process along a fold along the longitudinal axis X, a part of the body can move away from the main plane to form the wings. The wings make it possible for the load to be distributed over the entire length of the anchor, for example with a delta shape starting from the head. The wings generally extend in a plane outside the main plane of the body.

This anchor can also be used as a reinforcement. As shown in FIG. 16A, the anchor with the delta-shaped wings is superimposed on an anchor shown in FIG. 14A. In order to increase the stability between the reinforcement and the anchor, insertion structures can be provided for. For example, the foot portion can be deleted in the reinforcement of FIG. 16A and the pin can be added. Correspondingly, the notch is inserted on the anchor foot to receive the reinforcement pin insertion. It is also possible to keep a part of the foot of the reinforcement as shown in FIG. 16B. When the reinforcement is superimposed on the anchor, the diverging foot part of the reinforcement is superimposed on the two diverging foot branches of the anchor.

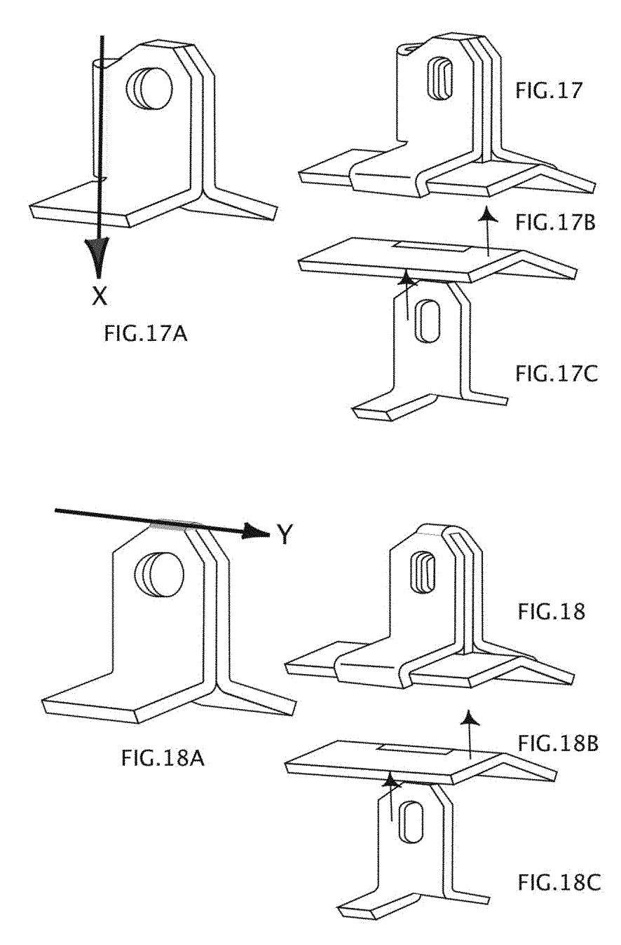

In the following paragraphs, an anchor assembly with a reinforcement and a plate is described. In a first embodiment, the anchor is produced through a lateral folding of a single flat. FIG. 17A shows an anchor formed by a lateral folding of the two sub-parts along a fold along the longitudinal axis X. It is possible to provide some space between the two sub-sections. FIG. 17B shows a roof-shaped plate, which follows the angle of the two diverging branches of the foot portion of the anchor. A slot-shaped aperture is provided on the upper part of the roof. FIG. 17C shows an inverted Y-shaped reinforcement. The arrows between FIGS. 17 B and C show the direction of insertion of the reinforcement, through the slot of the plate, into the space between the two sub-parts of the anchor. FIG. 17 shows the assembly of the three parts.

In a second embodiment, the anchor is achieved by a longitudinal folding of a single flat. FIG. 18A shows an anchor formed by a longitudinal folding of the two sub-parts along a fold along the lateral axis Y. It is possible to provide some space between the two sub-sections. FIG. 18B shows a plate identical to the one described in FIG. 17B. FIG. 18C shows an inverted Y-shaped reinforcement identical to the one described in FIG. 17C. The arrows between FIGS. 18 B and C show the direction of insertion of the reinforcement, through the slot of the plate, into the space between the two sub-parts of the anchor. FIG. 18 shows the assembly of the three parts.

Of course, the particularities of the embodiments, such as the number of folds in the X or Y direction, the number of sub-parts of the anchor, the sequence of folding, the different thicknesses, the different reinforcing and securing means can vary and can be combined together to define an optimal dynamic anchor according to the building element.

1. A lifting anchor for lifting a building element, comprising a head part configured to be attached to a gripping ring, a foot and a body interposed between the head and the foot, the body and the foot configured to be immersed in material of which the building element is made, the anchor extending in a main plane along a longitudinal axis and comprising at least two sub-parts, each defining various successive portions respectively forming the head, the body and the foot of the anchor, at least one reinforcement interposed between the two sub-parts, extending from the head of the anchor over at least part of the foot.

2. An anchor according to claim 1, wherein the anchor is obtained by folding a single flat comprising at least two continuously connected sub-parts of the anchor.

3. An anchor according to claim 1 wherein the anchor includes at least two separate sub-parts, each one being obtained by folding at least one flat.

4. An anchor according to claim 1, wherein the reinforcement is an independent part interposed on the anchor.

5. An anchor according to claim 1, wherein the reinforcement is a part continuously connected with the anchor, obtained by folding a flat containing at least a sub-part of the anchor.

6. An anchor according to claim 1, wherein constituent portions of the foot of the anchor comprising two lower branches diverging on either side of the anchor body, and two branches converging towards each other and extending from the diverging branches.

7. An anchor according to claim 6, further comprising means for locking the converging branches against one another.

8. An anchor according to claim 7, wherein the means for locking one converging branch to the other comprise at least one protrusion formed on the lower free edge of the converging branch, and a recess for accommodating such protrusion, provided in the thickness of the opposite converging branch from the lower free edge thereof, with the protrusion being engaged into the recess when the portions of the flat heads of the anchor and the reinforcing part interposed between same, are pressed against each other.

9. An anchor according to claim 8, wherein the locking means comprise a single protrusion transversally offset relative to the center of the free edge of the converging branch, and a cut forming the accommodating recess, with the two lower free edges of the two converging branches each comprising a single protrusion and one cut.

10. An anchor according to claim 8, wherein the locking means comprise several protrusions and several cuts, with the protrusions and the cuts alternating along the lower free edge of the converging branch, with the two lower free edges of the two converging branches each having several protrusions and several cuts forming notches.

11. An anchor according to claim 7, wherein the reinforcement comprises a hole for passage of the locking means provided in the thickness of same.

12. An anchor according to claim 1, further comprising at least one outer tilt-up rib on each of external faces of the two paired flats.

13. An anchor according to claim 12, wherein the outer rib extends along a longitudinal axis of the anchor or along an inclined direction relative to such axis.

14. An anchor according to claim 1, wherein the two paired flats, and/or at least one of the flats and the central reinforcement are secured together by a material bridge formed by a portion of a flat folded along a folding line.

15. An anchor according to claim 14, wherein the folding line extends along a side edge of the anchor head, or an upper edge of the anchor head or a lower edge of the anchor foot.

16. An anchor according to claim 1, further comprising at least one lateral return along the body, extending along a plane outside the main plane of the body.

17. An anchor according to claim 1, further comprising a lateral return having a delta shape starting from the head.
